(19) United States
(12) Patent Application Publication
(10) Pub. No.: US 2024/0034011 A1
(43) Pub. Date: Feb. 1, 2024

(54) SYSTEM AND METHOD OF REPAIR FOR GLUED PLASTIC AND FIBERGLASS PARTS OF CARS AND TRUCKS

(71) Applicant: Serafim Semenas, Vilnius (LT)

(72) Inventor: Serafim Semenas, Vilnius (LT)

(21) Appl. No.: 17/877,511

(22) Filed: Jul. 29, 2022

(51) Int. Cl. B29C 73/34; B29C 73/02; B29C 65/50

(52) U.S. Cl. CPC B29C 73/34; B29C 73/02; B29C 65/5007; B29L 2031/3005

(57) ABSTRACT

Provided is a system and method of repair for glued plastic and fiberglass parts of cars and trucks. The system includes a flexible thermal tape with electrical heating element, power source, and a securement means. The thermal tape is configured to generate temperatures in a range of 760-degrees Celsius to 960-degrees Celsius to melt the glue holding two components together. The method of repair includes providing a flexible thermal tape as described above, affixing the tape to a damaged component of a vehicle, engaging the power source to supply power to the heating element in the tape, and providing power from the power source to the heating element in the flexible thermal tape for a period of time in the range of 30 minutes to 40 minutes.

### FIELD OF INVENTION

The invention relates generally to repair methods for vehicular components. More particularly, it relates to processes of replacing a single component of a multi-component vehicular body panel by heating the glue that holds the seam binding the components together an replacing with a new piece.

### BACKGROUND

The body of many vehicles now include components fabricated from plastics and fiberglass. These malleable parts are incorporated for a number of reasons, which may include cost of manufacture, weight benefits, and absorption of forces during accidents. Some vehicle parts are made of multiple components that are then glued together to form a single structure. That is, these parts may be glued together from various numbers of components, depending on the construction of the part. For example, the hood of some tractor trailers is made up of five separate components all glued together. However, unlike metal components, which can be hammered out to reshape after an accident, the plastic and fiberglass components typically fracture and are unrepairable after an accident. This results in the necessity to replace the entire vehicle part after the damage occurs. In the example of a tractor trailer hood, this can exceed five thousand dollars.

Some methods have been created to repair the components rather than replacing the entire thing. These methods lessen the financial burden associated with replacing a major component by separating the individual components and replacing only the damaged component. This cuts down on the amount of waste generated from discarding damaged components. The current method created to solve this problem includes using a heat gun to heat the seam of the vehicular part where two components have been glued together. Such methods typically require several hours to repair because the technician has to spot treat the seam by hand and separate the components inch by inch by prying them apart as the glue is heated to a point where the components can separate, and repeating this process all the way down the seam.

The above method accomplishes the goal of reducing wasted components at the expense of a longer process and increased labor costs. In addition, using the heat gun can damage and burn the vehicular components that are not being replaced, as well as creating smoke and harmful fumes that may be inhaled by the technician.

Therefore, a need currently exists in the industry for a method of replacing a single damaged component of a vehicle that is both cost effective and time effective and is not harmful the health of the technician repairing the component.

### SUMMARY OF THE INVENTION

Provided is a system and method of repair for glued plastic and fiberglass parts of cars and trucks.

The system providing for the repair of multi-component vehicle parts includes a flexible thermal tape comprising a continuous electrical heating element spanning a length of said flexible thermal tape. The flexible thermal tape includes a power source for supplying current to resistive wires. These resistive wires are configured for generating temperatures in a range of 760-degrees Celsius to 960-degrees Celsius. The temperature depends on the technical characteristics of the glue or adhesive used on the part, and the temperature may be higher or lower than 960-degrees Celsius depending therefrom. The temperature can be adjusted according to the characteristics of the part. Also provided in the system for repair of multi-component vehicle parts is a means for temporarily affixing the flexible thermal tape to a surface of a damaged vehicle component.

The method of repair glued multi-component vehicle parts includes providing a flexible thermal tape having a continuous electrical heating element spanning a length of said flexible thermal tape, wherein the electrical heating element is at least one resistive wire powered by a power source. The method continues by providing a means for temporarily affixing said flexible thermal tape to a surface of a multi-component vehicle part and affixing the flexible thermal tape on a damaged vehicle component along a seam of a multi-component vehicle part. Next, the method includes engaging the power source to supply power to the heating element in the flexible thermal tape, thereby generating temperatures in a range of 760-degrees Celsius to 960-degrees Celsius to loosen, dissolve, melt, or otherwise disengage an adhesive means connecting two vehicle components at said seam. Once engaged, the method continues by providing power from the power source to the heating element in the flexible thermal tape for a period of time in the range of 30 minutes to 40 minutes. This method can be used in all areas where there are glued parts, it can be used in aviation, space, construction, furniture production and all other areas where there are glued parts made of plastic, fiberglass, metal, ceramics, and all other materials that can withstand high temperatures. It is a very convenient, easy and safe working method. Further, the goal is the convenience of work because you don't have to stand and watch. For example, three times the working time is saved. The number of parts is saved, the number of discarded parts is saved, and thus the ecology is protected.

It is an object of the invention to provide a system that reduces the associated financial cost and waste generated from a replacement of a vehicular component.

It is a further object of the invention to have a system and method of repair that significantly reduces the time required to repair multi-component parts that are glued together to form a single vehicle part.

It is yet further an object to have a system and method that removed the hazardous conditions, associated with earlier methods of repairing multi-component vehicle parts, of smoke and creation of hazardous gasses caused by burning the chemicals in the adhesive to separate the individual components in a multi-component vehicle part.

It is also an object of the current invention to provide a system that reduces the amount of damage and burning to the un-damaged portions of the vehicle component during repair.

The drawings and specific descriptions of the drawings, as well as any specific or alternative embodiments discussed, are intended to be read in conjunction with the entirety of this disclosure. The invention may be embodied in many different forms and should not be construed as being limited to the embodiments set forth herein; rather, these embodiments are provided by way of illustration only and so that this disclosure will be thorough, complete and fully convey understanding to those skilled in the art. The above and yet other objects and advantages of the present invention will become apparent from the hereinafter set forth Brief Description of the Drawings, Detailed Description of the Invention, and Claims appended herewith.

### BRIEF DESCRIPTION OF THE DRAWINGS

FIG. 1 illustrates an enlarged front perspective view of the passenger side of a truck hood.

FIG. 2 illustrates an enlarged perspective view of the passenger side of a truck hood with tools used in previous methods.

FIG. 3 illustrates an enlarged perspective view of the passenger side of a truck hood with a first embodiment of a thermal tape engaged with a damaged piece of the hood.

FIG. 4 illustrates an enlarged perspective view of the passenger side of a truck hood with a first embodiment of a thermal tape engaged with a damaged piece of the hood.

FIG. 5 illustrates an enlarged view of the thermal tape of FIG. 3.

FIG. 6 illustrates an enlarged view of the thermal tape of FIG. 4.

FIG. 7 illustrates a flow diagram of the method of repair of damaged vehicular components.

### DETAILED DESCRIPTION OF THE INVENTION

The invention provides a system and method of repair for glued plastic and fiberglass parts of cars and trucks. The system includes a flexible thermal tape 102 with electrical heating element 104, power source 106, and a securement means 108/110. The thermal tape 102 is configured to generate temperatures in a range of 760-degrees Celsius to 960-degrees Celsius to melt the glue holding two components 112/114 together. The method of repair includes providing 202 a flexible thermal tape 102 as described above, affixing 206 the tape 102 to a damaged component of a vehicle 112, engaging 210 the power source 106 to supply power to the heating element 104 in the tape 102, and providing 212 power from the power source 106 to the heating element 104 in the flexible thermal tape 102 for a period of time in the range of 30 minutes to 40 minutes.

The invention provides a solution for the problems that arise with damaged multi-component plastic and fiberglass vehicle parts. As discussed above, many vehicle parts are constructed of multi-component pieces, which eases manufacturing. In the embodiment of a semi-truck's hood, also known as a cap, the hood is a large piece that pivots to allow a mechanic access to the engine. However, because of the size, it is not as feasible to make the hood out of one single piece. Rather, manufacturers combine different parts using adhesives, such as glue, to bond the different parts in to one piece during assembly. However, when an accident occurs damaging the hood, the bonded components are not easily separated for ease of repair, and thus, some have sought to replace the entire hood. This is very uneconomical and very unecological to change the entire part because there are many healthy components that can serve for a long time. Certain methods have been developed that seek to melt the glue and break the bonds between these components, however, they are time consuming and create smoke and hazardous fumes.

The invention herein uses a linear flexible thermal tape to speed up the process. The use of heating tape facilitates, accelerates and protects the entire work process, the temperature and time of the tape depends on the technical characteristics of the glue and the parts that are used. The tape is positioned on a damaged component parallel to the seam that bonds the components. The linear flexible thermal tape provides continuous heat through out the span, allowing uniform melting of the glue. Because a technician does not need to spot heat the seam with a heat gun and pry inch by inch, the time is reduced from about three hours to approximately half of an hour. Temperatures in the thermal tape operate at approximately 700-degrees Celsius and above, though 760-degrees Celsius is a preferred temperature; the higher the temperature, the faster the adhesive will melt or break. However, the technician will still need to keep an eye on the components to observe for burning or discoloration because conditions may vary, and different glues and adhesives have different characteristics. The time required may need to be extended or shortened depending on these conditions. In many applications, after about thirty minutes the technician should be able to dislodge the damaged component from the remainder of the multi-component vehicle piece.

The remainder of the process is fairly simple. The damaged component can be pried away easily, if not already dislodged. The technician may then choose to clear away any debris or residue from the seam. Once the damaged component is removed and the seam area is ready to receive a new component, the technician may add new adhesive and install the replacement part. This process saves the vehicle owner from replacing the entire hood and/or multi-component vehicle piece, saves several hours over using a heat gun, and can ultimately be the most cost-effective solution for the market. It will be an innovation that will undoubtedly be very popular due to its ease of use, efficiency, ecology and safety.

When comparing the invention herein to prior means of repair, the invention herein should become the dominant process, not only for the time and cost savings, but also for the reduced health and environmental impacts. Because the parts can be replaced individually, larger vehicular components will not be sent to a landfill. In addition, the current invention overs a unique advantage over prior means of repair because it does not generate harmful fumes and smoke. With the disclosure of the invention herein, it would be unclear why a technician would choose to use any prior means of repair given the teachings herein. Further, this method is completely safe in terms of combustion because there is no hot blowing air. With the prior methods used, there is very high temperature hot air which often causes the surface to catch fire and thus very dangerous. The method disclosed herein is completely safe in terms of fire, because when there is no blowing air/wind there is no fire.

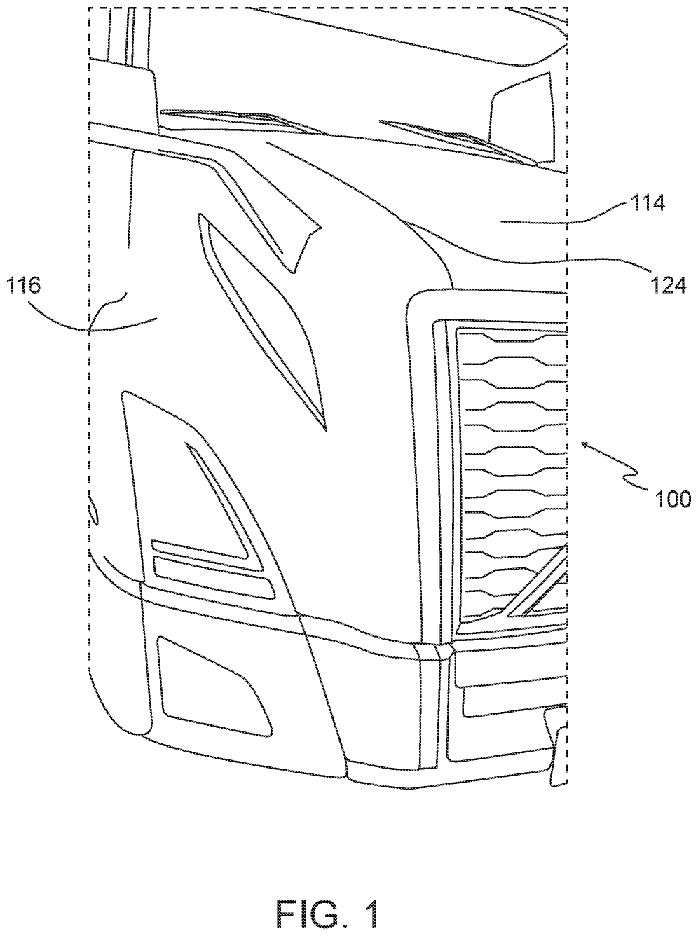

FIG. 1 illustrates an enlarged front perspective view of the passenger side of a truck hood representing a multi-component vehicle part 100. FIG. 1 contains views of the hood with the non-damaged vehicle component 114, new replacement component 116, and the seam 124.

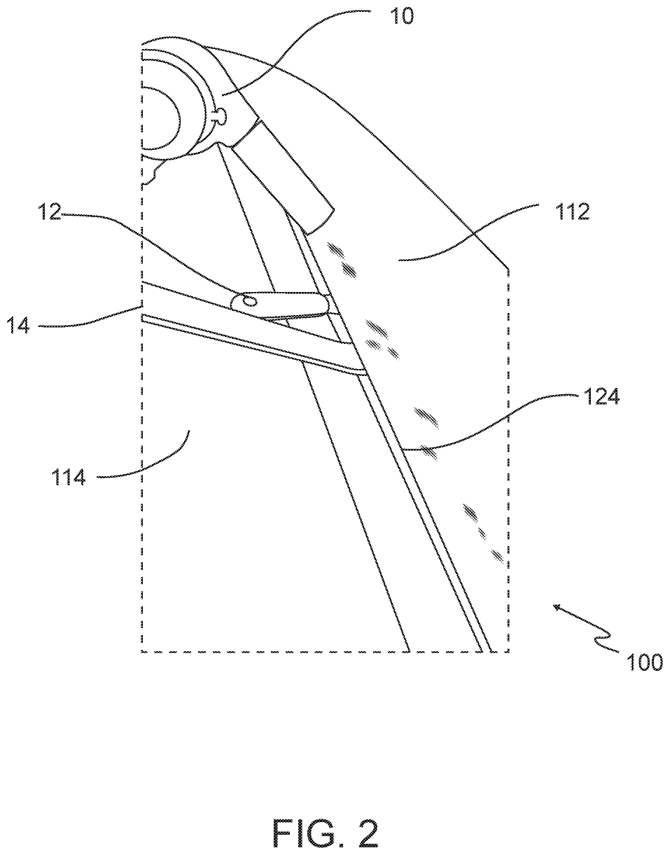

FIG. 2 illustrates an enlarged perspective view of the passenger side of a truck hood, representing a multi-component vehicle part 100, with tools 10/12/14 used in methods predating this invention, including heat gun 10, crowbar 14, and scraper 12. FIG. 2 also contains views of the non-damaged vehicle component 114, damaged component 112, and the seam 124.

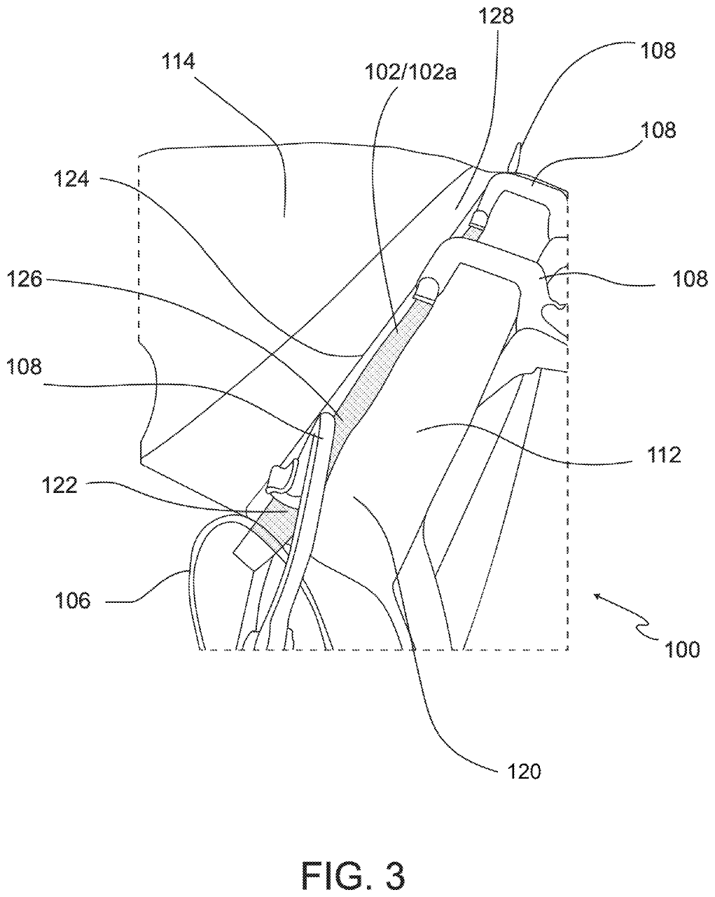

FIG. 3 illustrates an enlarged perspective view of the passenger side of a truck hood, representing a multi-component vehicle part 100, with a first embodiment of a thermal tape 102 engaged with a damaged piece of the hood 112. FIG. 3 contains views of the non-damaged vehicle component 114, damaged component 112, and the seam 124. Further shown is the flexible thermal tape 102 in a first embodiment form 102a, i.e., the form of a braided sheath 126. The insulative adhesive tape 128 is shown running parallel to the seam 124 to protect the undamaged portion 114 of the vehicle part 100. As may be seen, a plurality of clamps 108 affix the tape 102 to the top surface 120 of the damaged component 112 by putting pressure on the top surface 122 of said flexible thermal tape 102. The power source 106 is also shown.

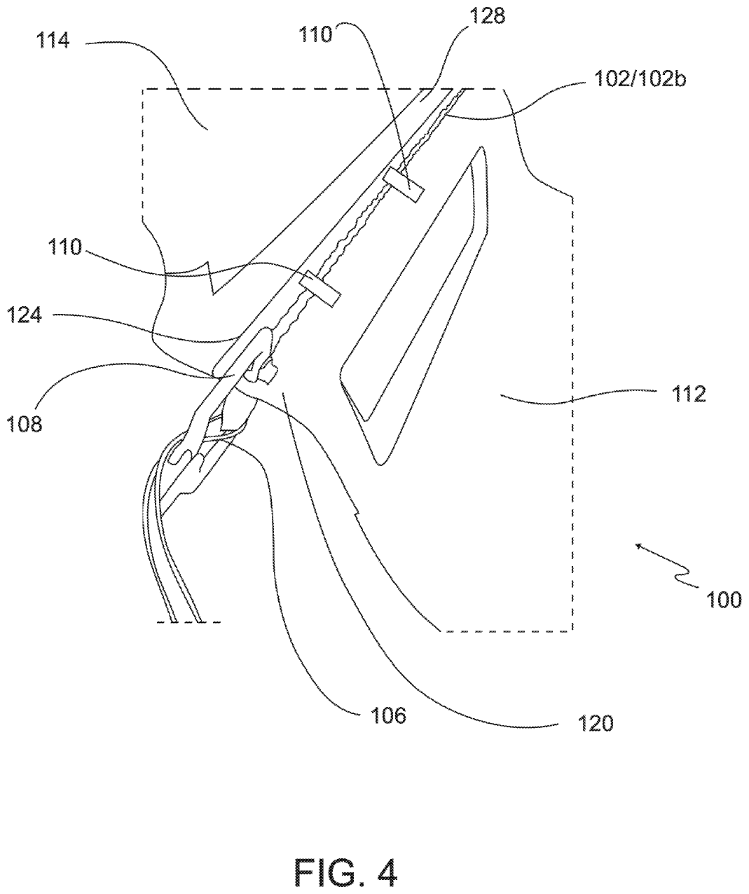

FIG. 4 illustrates an enlarged perspective view of the passenger side of a truck hood 100 with a second embodiment of a thermal tape 102 engaged with a damaged piece of the hood 112. FIG. 4 contains views of the non-damaged vehicle component 114, damaged component 112, and the seam 124. Further shown is the flexible thermal tape 102 in a second embodiment form 102b, i.e., a coiled and braded form. The insulative adhesive tape 128 is shown running parallel to the seam 124 to protect the undamaged portion 114 of the vehicle part 100. As may be seen, at least one clamps 108 and a plurality of adhesive tape strips 110 affix the tape 102 to the top surface 120 of the damaged component 112. The power source 106 is also shown.

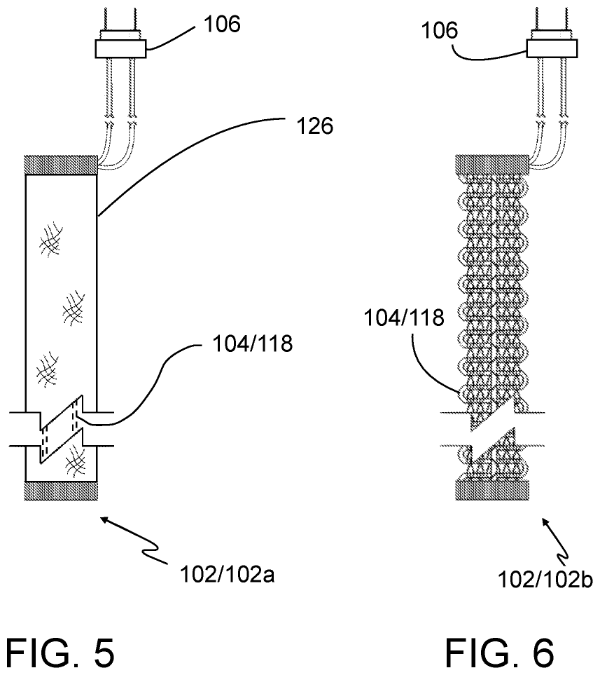

FIG. 5 illustrates an enlarged view of the thermal tape 102 of FIG. 3. FIG. 5 contains views of the flexible thermal tape 102 in a first embodiment form 102a, power source 106, electrical heating element 104 comprising resistive wires 118, and braided sheath 126.

FIG. 6 illustrates an enlarged view of the thermal tape 102 of FIG. 4. FIG. 6 contains views of the flexible thermal tape 102 in a second embodiment form 102b, wherein the heating element 102b is coiled and braded to provide a greater cross-sectional coverage than that of an uncoiled linear electrical heating element and allow for increased flexibility. Further shown are the power source 106, and electrical heating element 104 comprising resistive wires 118.

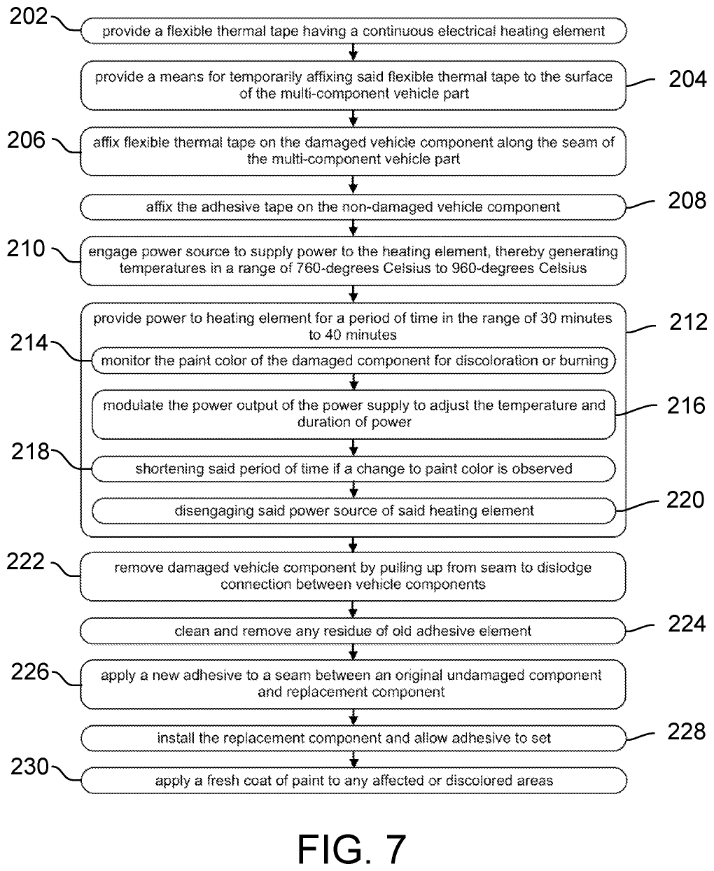

FIG. 7 illustrates a flow diagram of the method of repair of damaged vehicular components. FIG. 7 contains views of the steps of providing 202 a flexible thermal tape having a continuous electrical heating element, providing 204 a means for temporarily affixing the flexible thermal tape to the surface of the multi-component vehicle part, affixing 206 the flexible thermal tape on the damaged vehicle component along the seam of the multi-component vehicle part, affixing 208 the insulative adhesive tape on the non-damaged vehicle component, engaging 210 the power source to supply power to the heating element, thereby generating temperatures in a range of 760-degrees Celsius to 960 degrees Celsius, providing 212 power to the heating element for a period of time in the range of 30 minutes to 40 minutes, monitoring 214 the paint color of the damaged component for discoloration or burning, modulating 216 the power output of the power supply to adjust the temperature and duration of power, shortening 218 the period of time if a change to paint color is observed, disengaging 220 the power source of the heating element, removing 222 the damaged vehicle component by pulling up from the seam to dislodge the connection between the vehicle components, cleaning and removing 224 any residue of old adhesive elements, applying 226 a new adhesive to a seam between an original undamaged component and a replacement component, installing 228 the replacement component and allowing the adhesive to set

In an exemplary embodiment of the invention, shown in FIGS. 1, and 2-6, a system providing for the repair of multi-component vehicle parts 100 includes a flexible thermal tape 102 comprising a continuous electrical heating element 104 spanning a length of the flexible thermal tape 102. The flexible thermal tape 102 includes a power source 106 for supplying current to resistive wires 118 within the flexible thermal tape 102. The resistive wires 118 are configured for generating temperatures in a range of 760-degrees Celsius to 960-degrees Celsius, which is sufficient to melt the glue that may hold two body components 112/114 of a vehicle together. The system also includes a means 108/110 for temporarily affixing said flexible thermal tape 102 to a surface 120 of a damaged vehicle component 112. Because the thermal tape 102 is configured to heat adhesive to a point where it no longer binds, the tape 102 itself cannot contain an adhesive coating. Therefore, a separate and external means 108/110 for temporarily affixing is necessary.

In some embodiments of the system, the means 108/110 for temporarily affixing said flexible thermal tape 102 to a surface 120 of said damaged vehicle component 112 is at least one clamp 108 capable of applying pressure to a top surface 122 of said flexible thermal tape 102 at a first clamp 108 surface, and a pressure to an underside surface (not shown, but may be appreciated in FIGS. 3 and 4) of said damaged vehicle component 112, thereby keeping said flexible thermal tape 102 tightly engaged to said surface 120 of the damaged vehicle component 112. In many applications, there will be several clamps 108 to keep the tape 102 tight to the seam 124 so the tape 102 does not droop. However, sometimes the arrangement and curvatures of the vehicle's body components 112/114/116 do not allow for a clamp 108 to engage with both the top surface 120 and the bottom surface in a sufficient interval to keep the thermal tape 102 tightly engaged. Therefore, in some embodiments, the means 108/110 for temporarily affixing said flexible thermal tape 102 to a surface 120 of said damaged vehicle component 112 is an adhesive tape 110 capable of withstanding temperatures in a range of 760-degrees Celsius to 960-degrees Celsius, wherein said adhesive tape 110 may be applied in a plurality of strips at intervals spanning the length of said flexible thermal tape 102.

In some embodiments of the system, the flexible thermal tape 102a is constructed of braided sheath 126 surrounding said electrical heating element 104. The heating element 104 may be 36-40 gage stranded resistance wire, or equivalence thereof. In some embodiments, the dielectric strength is about 2000V. The power supply 106 may accept 120V power, or may accept 240V power depending on the output of the facility the repair is taking place at. The covering 126 to the heating element may be constructed of fiberglass, or in some embodiments, Samox™ or equivalent material. In some embodiments, depending on the surface of application, the heating element 102b is coiled and braded to provide a greater cross-sectional coverage than that of an uncoiled linear electrical heating element and allow for increased flexibility.

In another exemplary embodiment of the invention, a method of repair of glued multi-component vehicle parts is provided. This method is shown primarily in FIG. 7, using the system as illustrated in FIGS. 1 and 2-6. The method includes the steps of providing 202 a flexible thermal tape 102 having a continuous electrical heating element 104 spanning a length of said flexible thermal tape 102, providing 204 a means 108/110 for temporarily affixing said flexible thermal tape 102 to a surface 120 of a multi-component vehicle part 100, affixing 206 said flexible thermal tape on a damaged vehicle component 112 along a seam 124 of a multi-component vehicle part 100, engaging 210 said power source 106 to supply power to said heating element 104 in said flexible thermal tape 102, thereby generating temperatures in a range of 760-degrees Celsius to 960-degrees Celsius to loosen, dissolve, melt, or otherwise disengage an adhesive means connecting two vehicle components 112/114 at said seam 124, and providing 212 power from said power source 106 to said heating element 104 in said flexible thermal tape 102 for a period of time in the range of 30 minutes to 40 minutes. The electrical heating element 104 has at least one resistive wire 108 powered by a power source 106.

In the step of providing 202 a flexible thermal tape 102, the flexible thermal tape 102 may be constructed of braided sheath 126 surrounding said electrical heating element 104, or may be coiled and braded, as shown in FIGS. 4 and 7, to provide a greater cross-section then that of the electrical heating element 104 and allow for increased flexibility.

In some embodiments of the method of repair for glued multi-component vehicle parts, the step of providing 212 power from the power source 106 to the heating element 104 in the flexible thermal tape 102 for a period of time in the range of 30 minutes to 40 minutes further includes the steps of: monitoring 214 a paint color of said damaged vehicle component 112 for discoloration or burning, shortening 218 said period of time if a change to paint color is observed, and disengaging 220 said power source 106 of said heating element 104. This may further reduce the lower range of time to 20 minutes. Thereby, an additional step of adjusting a temperature and duration in relation to the previous step may be accomplished by modulating 216 a power output of said power supply 106 based on the technical characteristics of the adhesive means connecting said two vehicle components 112/114. It is important for the technician to monitor the progress of the heating element 104 to ensure damage is not done to the remaining parts 114 of the vehicle component 100.

In addition to the above steps, a user may wish to perform the following steps to prevent damage. These steps include affixing 208 an insulative adhesive tape 128 on a non-damaged vehicle component 114 on an opposing side of the seam 124 of a multi-component vehicle part 100, prior to said step of engaging 210 said power source 106 to supply power to said heating element 104 in said flexible thermal tape 102. The insulative adhesive tape 128 is configured to protect the non-damaged vehicle component 114 from excessive temperatures during a heating process.

When the heating process is complete, a technician may want to continue by cleaning and removing 224 any residue remaining from said adhesive element from said seam 124. Upon clearing away any residue, or if no residue is left, a technician may continue the repair by removing 222 the damaged vehicle component 112 once the adhesive means is loosened, dissolved, melted, or otherwise disengaged by pulling up from the seam 124 to dislodge any remaining connection between said damaged vehicle component 112 and any other vehicle component 114. The technician may then continue by applying 226 a new adhesive to a seam 124 between an original undamaged component 114 and a new replacement component 116, and installing the new replacement vehicular component 116 and allowing the adhesive to set. In some installations, the heating element 104 may have caused some discoloration to one or more components. To finalize the repair, the technician may want to conclude by installing 228 the new replacement vehicular component 116 and allowing said adhesive to set, then applying 230 a fresh coat of paint to any affected or discolored areas.

By incorporating this method into the repair of certain plastic, fiberglass and the like repairs, a technician can save tremendous amounts of time, which reduces the cost to the user. In addition, using the above system and method, less hazardous gas and smoke is created, making the current method safer than other methods currently in the market.

While there has been shown and described above the preferred embodiment of the instant invention it is to be appreciated that the invention may be embodied otherwise than is herein specifically shown and described and that certain changes may be made in the form and arrangement of the parts without departing from the underlying ideas or principles of this invention as set forth in the Claims appended herewith.

I claim:

1. A system providing for the repair of multi-component vehicle parts, comprising:
a flexible thermal tape comprising a continuous electrical heating element spanning a length of said flexible thermal tape;
said flexible thermal tape including a power source for supplying current to resistive wires;
said resistive wires are configured for generating temperatures in a range of at least 760-degrees Celsius to at least 960-degrees Celsius; and
a means for temporarily affixing said flexible thermal tape to a surface of a damaged vehicle component.

2. The system providing for the repair of multi-component vehicle parts, as recited in claim 1, wherein said means for temporarily affixing said flexible thermal tape to a surface of said damaged vehicle component is at least one clamp capable of applying pressure to a top surface of said flexible thermal tape at a first clamp surface, and a pressure to an underside surface of said damaged vehicle component, thereby keeping said flexible thermal tape tightly engaged to said surface of said damaged vehicle.

3. The system providing for the repair of multi-component vehicle parts, as recited in claim 1, wherein said means for temporarily affixing said flexible thermal tape to a surface of said damaged vehicle component is an adhesive tape capable of withstanding temperatures in a range of 760-degrees Celsius to 960-degrees Celsius, wherein said adhesive tape may be applied in a plurality of strips at intervals spanning the length of said flexible thermal tape.

4. The system providing for the repair of multi-component vehicle parts, as recited in claim 1, wherein the flexible thermal tape is constructed of braided sheath surrounding said electrical heating element.

5. The system providing for the repair of multi-component vehicle parts, as recited in claim 4, wherein said heating element is coiled and braded to provide a greater cross-section then that of the electrical heating element and allow for increased flexibility.

6. A method of repair glued multi-component vehicle parts, comprising:
providing a flexible thermal tape having a continuous electrical heating element spanning a length of said flexible thermal tape, wherein said electrical heating element is at least one resistive wire powered by a power source;
providing a means for temporarily affixing said flexible thermal tape to a surface of a multi-component vehicle part;
affixing said flexible thermal tape on a damaged vehicle component along a seam of a multi-component vehicle part;
engaging said power source to supply power to said heating element in said flexible thermal tape, thereby generating temperatures in a range of 760-degrees Celsius to 960-degrees Celsius to loosen, dissolve, melt, or otherwise disengage an adhesive means connecting two vehicle components at said seam; and
providing power from said power source to said heating element in said flexible thermal tape for a period of time in the range of 30 minutes to 40 minutes.

7. The method of repair for glued multi-component vehicle parts, as recited in claim 6, wherein said step of providing power from said power source to said heating element in said flexible thermal tape for a period of time in the range of 30 minutes to 40 minutes further includes the steps of:
monitoring a paint color of said damaged vehicle component for discoloration or burning;
shortening said period of time if a change to paint color is observed; and
disengaging said power source of said heating element.

8. The method of repair for glued multi-component vehicle parts, as recited in claim 6, further comprising:
adjusting a temperature and duration of power in said step of providing power from said power source to said heating element in said flexible thermal tape by modulating a power output of said power supply based on the technical characteristics of the adhesive means connecting said two vehicle components.

9. The method of repair for glued multi-component vehicle parts, as recited in claim 6, further comprising:
removing said damaged vehicle component once said adhesive means is loosened, dissolved, melted, or otherwise disengaged by pulling up from the seam to dislodge any remaining connection between said damaged vehicle component and any other vehicle component;
applying a new adhesive to a seam between an original undamaged component and a new replacement component;
installing said new replacement vehicular component and allowing said adhesive to set; and
applying a fresh coat of paint to any affected or discolored areas.

10. The method of repair for glued multi-component vehicle parts, as recited in claim 9, wherein said step of removing said damaged vehicle component further includes:
cleaning and removing any residue remaining from said adhesive element from said seam.

11. The method of repair for glued multi-component vehicle parts, as recited in claim 6, further comprising:
affixing an insulative adhesive tape on a non-damaged vehicle component on an opposing side of the seam of a multi-component vehicle part, prior to said step of engaging said power source to supply power to said heating element in said flexible thermal tape; and
said insulative adhesive tape is configured to protect the non-damaged vehicle component from excessive temperatures during a heating process.

12. The method of repair for glued multi-component vehicle parts, as recited in claim 6, wherein the flexible thermal tape, in the step of providing a flexible thermal tape, is constructed of braided sheath surrounding said electrical heating element.

13. The method of repair for glued multi-component vehicle parts, as recited in claim 6, wherein the flexible thermal tape, in the step of providing a flexible thermal tape, is coiled and braded to provide a greater cross-section then that of the electrical heating element and allow for increased flexibility.
